(19) United States
(12) Patent Application Publication
(10) Pub. No.: US 2015/0095100 A1
(43) Pub. Date: Apr. 2, 2015

(54) System and Method for Integrated Risk and Health Management of Electric Submersible Pumping Systems

(71) Applicant: GE Oil & Gas ESP, Inc., Oklahoma City, OK (US)

(72) Inventors: Sameer Vittal, Atlanta, GA (US); Chongchan Lee, Atlanta, GA (US); Romano Patrick, Atlanta, GA (US)

(73) Assignee: GE Oil & Gas ESP, Inc., Oklahoma City, OK (US)

(21) Appl. No.: 14/042,078

(22) Filed: Sep. 30, 2013

(51) Int. Cl. G06Q 10/06; F04B 49/06

(52) U.S. Cl. CPC G06Q 10/0635; F04B 49/065
USPC 705/7.28; 700/282

(57) ABSTRACT

A system and process for optimizing the performance and evaluating the risks of pumping systems includes the steps of measuring the operation and condition of components within a discrete electric submersible pumping system, accumulating these measurements across a field of electric submersible pumping systems, performing statistical analysis on the accumulated measurements and producing one or more selected outputs from the group statistical analysis. In the preferred embodiments, the statistical analysis and data processing occurs at both the individual pumping system and at one or more centralized locations.

### FIELD OF THE INVENTION

This invention relates generally to the field of data management systems, and more particularly to data management systems for use with oilfield equipment.

### BACKGROUND

Electric submersible pumping systems are often deployed into wells to recover petroleum fluids from subterranean reservoirs. Typically, a submersible pumping system includes a number of components, including one or more electric motors coupled to one or more pump assemblies. Electric submersible pumping systems have been deployed in a wide variety of environments and operating conditions. The high cost of repairing and replacing components within an electric submersible pumping system necessitates the use of durable components that are capable of withstanding the inhospitable downhole conditions.

Information about the failure of components in the past can be used to improve component design and provide guidance on best operating practices. Using failure rate information, manufacturers have developed recommended operating guidelines and approved applications for downhole components. Manufacturers often place sensors within an electric submersible pumping system and compare measured environmental and performance factors against a range of predetermined set points based on past failure rate information. If an “out-of-range” measurement is made, alarms can be used to signal that a change in operating condition should be made to reduce the risk of damage to the electric submersible pumping system. Based on historic failure information, projected failure rates can be derived from the detection and recordation of out-of-range operation incidents.

Although generally effective for identifying concerns in individual pumping systems following an out-of-range incident, there is a need for an improved system for evaluating the health of electric submersible pumping systems distributed across a wide area and deployed in varying applications. It is to this and other deficiencies in the prior art that the presently preferred embodiments are directed.

### SUMMARY OF THE INVENTION

In preferred embodiments, the present invention includes a system and process for measuring the operation and condition of components within a discrete electric submersible pumping system, accumulating these measurements across a field of electric submersible pumping systems, performing statistical analysis on the accumulated measurements and producing one or more selected outputs from the group statistical analysis. In the preferred embodiments, the statistical analysis and data processing occurs at both the individual pumping system and at one or more centralized locations.

In one aspect, the preferred embodiments include a process for producing a risk analysis report that includes the steps of providing a local control unit at each of the plurality of pumping systems and providing output signals to each of the plurality of local control units from each of the corresponding pumping systems. Each of the output signals is reflective of an operating condition measured at the pumping system.

The process continues by processing the output signals at each of the plurality of local control units and producing a health index at each of the plurality of local control units. The health index is then uploaded from each of the plurality of local control units to a central data center for further processing. At the central data center, the health indices received from the plurality of local control units are categorized and a multi-level survival model based on the categorized health indices is generated. The process continues by applying the health indices specific to a selected pumping system to the multi-level survival model and generating the risk analysis report for the selected pumping system based on the application of the specific health indices within the multi-level survival model.

In another aspect, the preferred embodiments include a process for optimizing the performance of a selected pumping system within a plurality of pumping systems. The process includes steps of producing a multi-level survival model at a central data center based on health indices generated at remote local control units. The process includes the steps of applying the health indices specific to the selected pumping system to the multi-level survival model to produce optimized operating instructions. The process further includes adjusting the operational characteristics of the selected pumping system in accordance with the optimized operating instructions.

### BRIEF DESCRIPTION OF THE DRAWINGS

FIG. 1 is a depiction of an electric submersible pumping system constructed in accordance with a presently preferred embodiment.

FIG. 2 is a functional depiction of the local control unit of the electric submersible pumping system of FIG. 1.

FIG. 3 is a functional diagram of a series of electric submersible pumping systems in network connectivity with a central data center.

FIG. 4 is a process flow diagram for a preferred method for producing health indices at an electric submersible pumping system.

FIG. 5 is a process flow diagram for producing an output report based on the health indices produced by the electric submersible pumping systems.

FIG. 6 is a graphical representation of health indices over time.

FIG. 7 is a graphical representation of the aggregated health indices of FIG. 6 with weighting factors.

FIG. 8 is a Gaussian surface representation of the aggregated health indices from FIG. 7.

### DETAILED DESCRIPTION OF PREFERRED EMBODIMENTS

Generally, the preferred embodiments are directed at an improved system and methodology for measuring the operation and condition of components within a discrete electric submersible pumping system, accumulating these measurements across a field of electric submersible pumping systems, performing statistical analysis on the accumulated measurements and producing one or more selected outputs from the group statistical analysis. Notably, the preferred embodiments represent a significant departure from prior art efforts because the statistical analysis and data processing occurs at both the individual electric submersible pumping system and at one or more centralized locations. Thus, the preferred embodiments include the use of hardware and software disposed at individual remote locations, centralized data processing facilities and the interconnecting network infrastructure. As used herein, the term “health index” refers to an expression of the condition of components within an electric submersible pumping system, where the condition is determined by an assessment of data produced by sensors within a particular electric submersible pumping system.

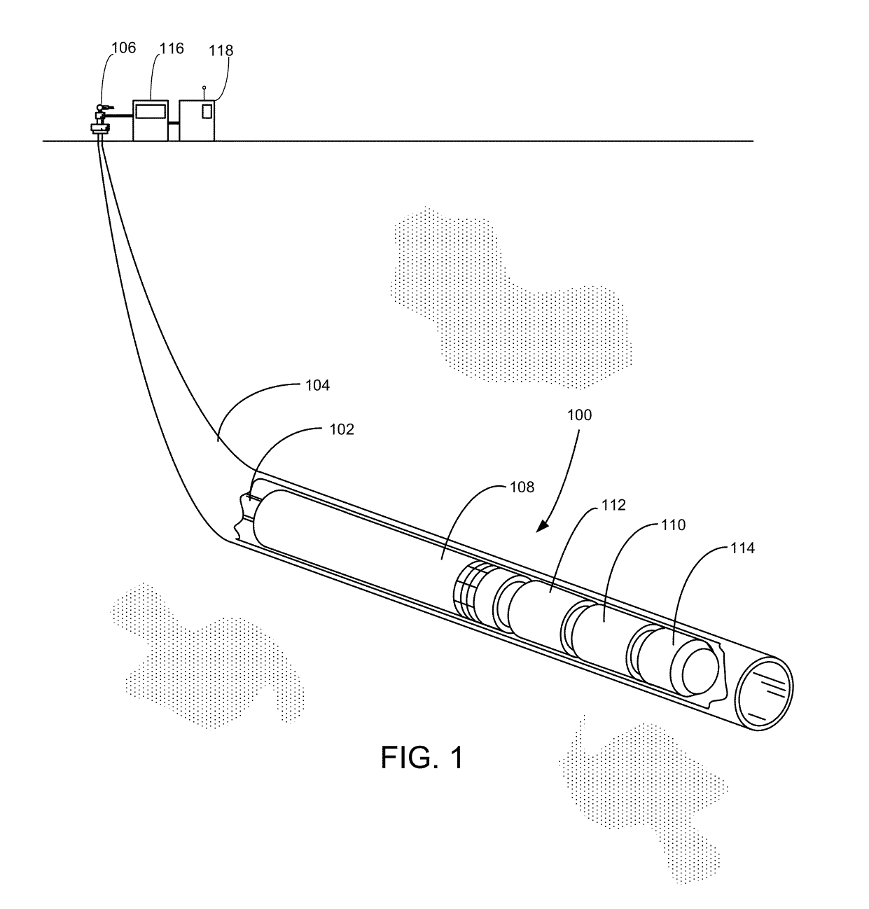

In accordance with a preferred embodiment of the present invention, FIG. 1 shows an elevational view of a submersible pumping system 100 attached to production tubing 102. The pumping system 100 and production tubing 102 are disposed in a wellbore 104, which is drilled for the production of a fluid such as water or petroleum. The production tubing 102 connects the pumping system 100 to a wellbore 106 and downstream surface facilities (not shown). Although the pumping system 100 is primarily designed to pump petroleum products, it will be understood that the present invention can also be used to move other fluids. It will be further understood that the depiction of the wellbore 104 is illustrative only and the presently preferred embodiments will find utility in wellbores of varying depths and configurations.

The pumping system 100 preferably includes some combination of a pump assembly 108, a motor assembly 110, a seal section 112 and a sensor array 114. The pump assembly 108 is preferably configured as a multistage centrifugal pump that is driven by the motor assembly 110. The motor assembly 110 is preferably configured as a three-phase electric motor that rotates an output shaft in response to the application of electric current at a selected frequency. In a particularly preferred embodiment, the motor assembly 110 is driven by a variable speed drive 116 positioned on the surface. Electric power is conveyed from the variable speed drive 116 to the motor assembly 110 through a power cable.

The seal section 112 shields the motor assembly 110 from mechanical thrust produced by the pump assembly 108 and provides for the expansion of motor lubricants during operation. Although only one of each component is shown, it will be understood that more can be connected when appropriate. For example, in many applications, it is desirable to use tandem-motor combinations, multiple seal sections and multiple pump assemblies. It will be further understood that the pumping system 100 may include additional components, such as shrouds and gas separators, not necessary for the present description.

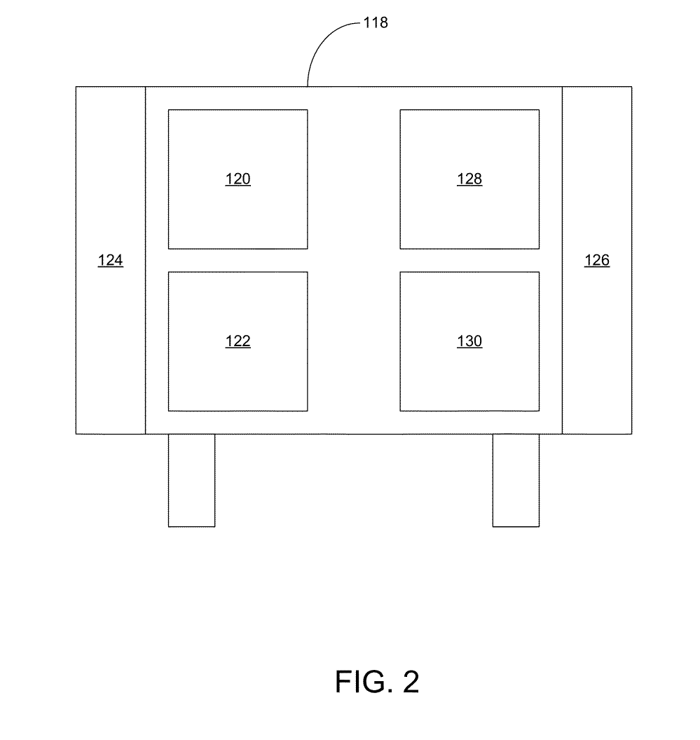

The pumping system 100 further includes a local control unit 118 connected to the variable speed drive 116. Turning to FIG. 2, shown therein is a functional depiction of the local control unit 118. The local control unit 118 preferably includes a data storage device 120, a central processing unit 122, a controls interface 124 and a communications module 126. The local control unit 118 optionally includes a graphic display 128 and user input device 130. In presently preferred embodiments, the local control unit 118 includes one or more computers and accompanying peripherals housed within a secure and environmentally resistant housing or facility.

The controls interface 124 is configured for connection to the variable speed drive 116 and directly or indirectly to the sensor array 114. The controls interface 124 receives measurements from the wellbore 104 and the various sensors within the electric submersible pumping system 100. The controls interface 124 outputs control signals to the variable speed drive 116 and other controllable components within the electric submersible pumping system 100.

The central processing unit 122 is used to run computer programs and process data. The computer programs, raw data and processed data can be stored on the data storage device 120. In particular, the central processing unit 122 is configured to determine health indices and other performance metrics for the pumping system 100 in accordance with preferred embodiments. The user input device 130 may include keyboards or other peripherals and can be used to manually enter information at the local control unit 118.

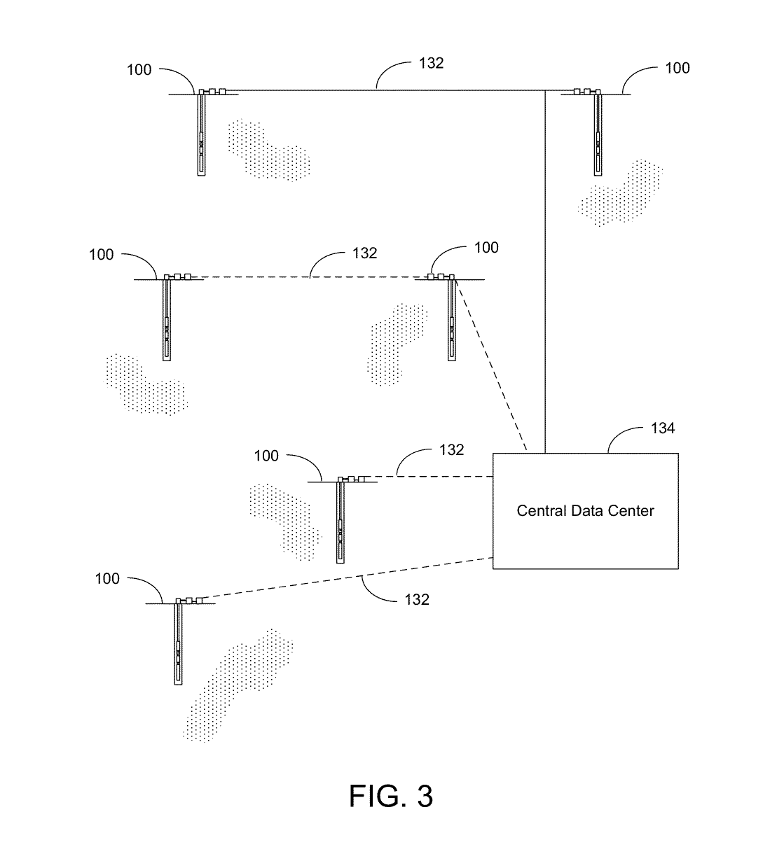

The communications module 126 is configured to send and receive data. The communications module 126 may be configured for wireless, wired and/or satellite communication. As depicted in FIG. 3, the communications module 126 places the local control unit 118 and electric submersible pumping system 100 on a network 132. The network 132 may include a multi-nodal system in which discrete electric submersible pumping systems 100 may act as both repeater and terminal nodes within the network 132. Whether through wired or wireless connection, each of the electric submersible pumping systems 100 are placed in two-way network connectivity to one or more central data centers 134. It will be understood that there are a wide range of available configurations encompassed by the preferred embodiment of the network 132.

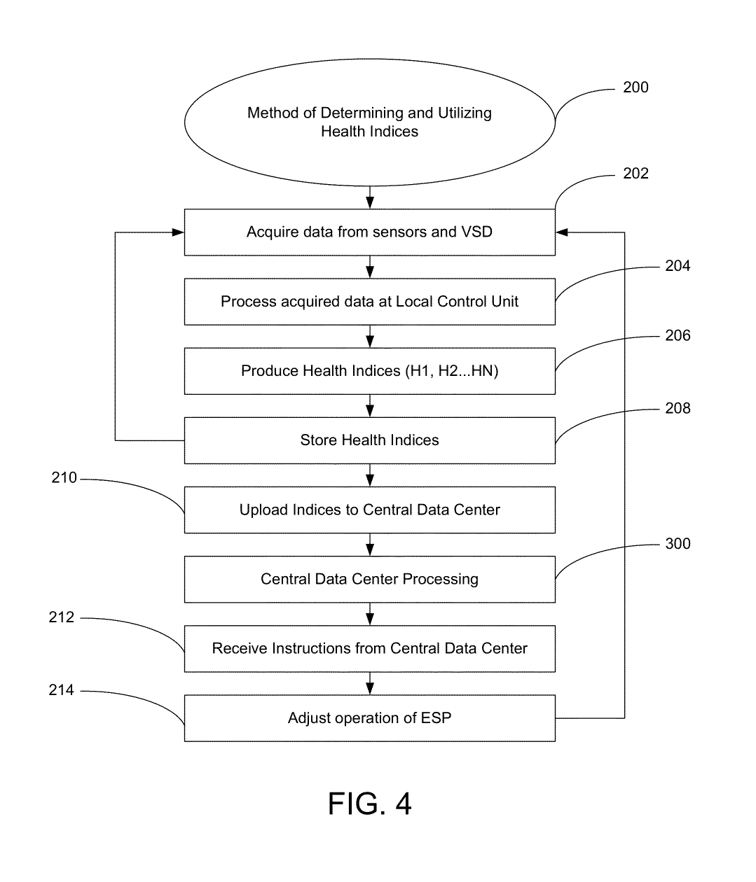

Turning to FIG. 4, shown therein is a process flow diagram for a preferred method of calculating and applying health indices 200 at the local control unit 118. It will be understood that, unlike prior art analytical systems, the preferred methods for calculating health indices for components within the pumping system 100 are calculated on-site within the local control unit 118. Thus, instead of gathering raw data to be processed at off-site locations, each local control unit 118 is configured to gather data from the pumping system 100, evaluate the raw data using statistical analysis and produce selected health indices reflective of the operating and structural conditions of the various components within the pumping system 100.

Beginning at step 202, the local control unit 118 receives data inputs related to the components and operation of the pumping system 100. These data inputs may be produced by the sensor array 114 of the pumping system 100, sensors located elsewhere in the pumping system 100 or presented to the local control unit 118 by the central data center 134. In particularly preferred embodiments, the local control unit 118 accepts the following sensor readings periodically (e.g., once per second, once per hour): Data Stamp, Motor Voltage (V), Motor Current (Amp), Power Factor (PF), Pump Intake Pressure (PIP), Motor Temperature Frequency (Hz), Pump Intake Temperature (PIT), Vibration (g's), Flowing Bottom Hole Pressure (FLP), Well Head Pressure (WHP) and Leakage Current (V-Unb).

Next, at step 204, the local control unit 118 processes the acquired data uniquely. At step 206, the local control unit 118 produces health indices for components within the pumping system 100, including for the pump assembly 108, motor assembly 110, seals and seal section 112, and variable speed drive 116. The health indices (H₁, H₂, . . . , Hₙ) represent expressions of the condition of the various components within the pumping system 100 and are generated by aggregating signals generated from a variety of sources within the pumping system 100 through use of multivariate statistical techniques. Presently preferred multivariate statistical techniques include, but are not limited to, probability-density based usage indices, multivariate Hotelling T-squared distributions, change point detection algorithms, and Bayesian and neural network-based anomaly detection and classification techniques. The generation of the health indices are time-stamped so that changes in health indices can be correlated against changes to the pumping system 100 or environment.

In a particularly preferred embodiment, the health indices are generated at the local control unit 118 using association rule mining (ARM) algorithms. The ARM rules are developed centrally using machine learning tools and deployed locally at the local control unit 118. The ARM algorithms produce binary rules (i.e., “1” or “0”) which represented conditions or alarms that are in either an alarmed or unalarmed state. The ARM algorithms are then presented to the preferred logistic regression to produce the particular health index.

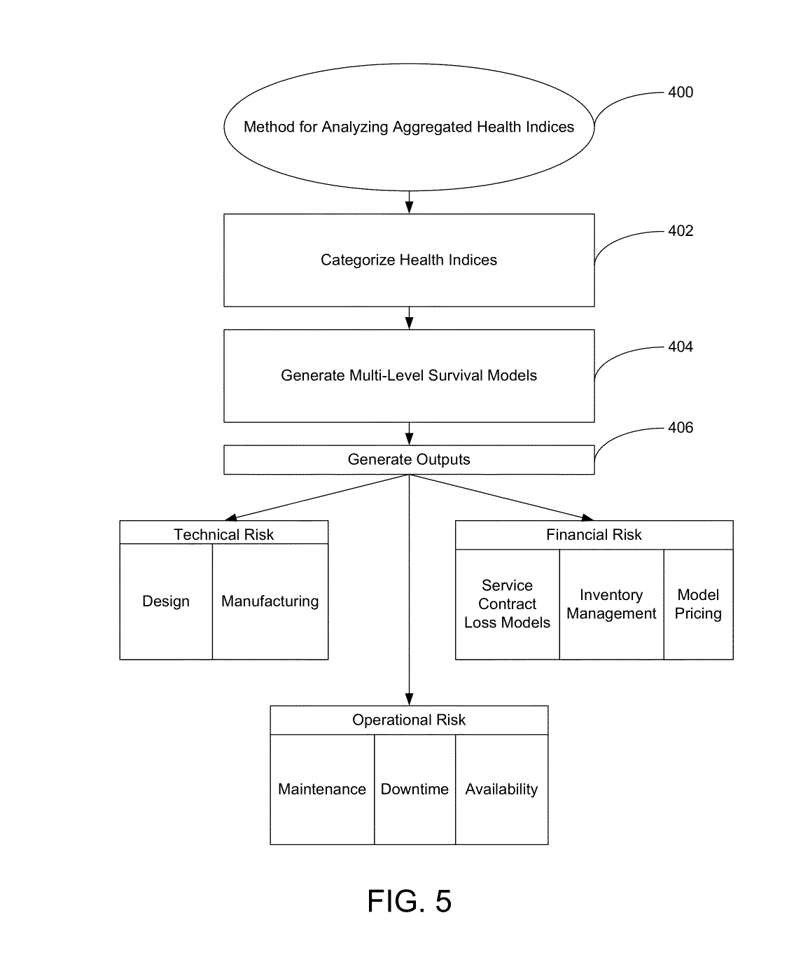

At step 208, the health indices are stored by the local control unit 118. As noted by the return flow in FIG. 4, the local control unit 118 will continue to accept measurement and data inputs and calculate health indices on a continuous, scheduled or on-demand basis. At step 210, some or all of the stored health indices are uploaded by the local control unit 118 to the central data center 134 across the network 132. The internal processes at the central data center 134 are depicted in the flow diagram of FIG. 5.

Continuing with FIG. 4, the local control unit 118 receives instructions from the central data center at step 212. In response to these instructions, the local control unit 118 can adjust the operation of the pumping system 100 at step 214 to improve performance, reduce wear to components and/or modify the output of the pumping system 100 in response to commercial factors. As adjustments are made to the operation of the pumping system 100, the local control unit 118 continues to acquire measurement and data inputs and calculate revised, time-stamped health indices.

Turning to FIG. 5, depicted therein is a process flow diagram for a method for analyzing aggregated health indices 400 at the central data center 134. At step 402, the health indices gathered from remote pumping systems 100 are gathered and categorized according to selected variables associated with the health indices. For example, databases are constructed using health indices received for common equipment models, common geographic regions, common downhole applications, etc.

At step 404, the central data center trends and applies statistical analysis to the gathered and categorized health indices to generate multi-level survival models. In a particularly preferred embodiment, the algorithms are used to produce multi-level survival models at regional, site and ESP levels. At the regional level, the analysis is directed at common macro geological features, such as whether the electric submersible pumping system is installed on land or subsea. At the site level, the analysis is directed at factors common to particular sites, such as the number of wells in an area, location of wells (geospatial), reservoir volume, production decline curve, oil API gravity (viscosity), average porosity, average permeability, rock compressibility, oil-in-place, gas-in-place, and reservoir stimulation history. At the ESP level, the analysis is focused on the discrete pumping system 100 and includes analysis on well depth, gas-oil-ratio, water-oil-ratio, pump-intake-pressure, suction temperature, solid abrasives, corrosive elements, flowing bottom hole pressure, static bottom hole pressure, well productivity index, inlet performance relationship, and well logs.

In a preferred embodiment, the failure risk (F(t)) is calculated for each pumping system 100 or specific component within the pumping system 100 using the health indices (H1 . . . Hn) and multi-level data using standard Weibull-Regression. In an alternate preferred embodiment, the failure risk F(t,u) is calculated using a Bivariate Weibull regression that incorporates an evaluation of risk based on time (t) and severity (u) of the observed health indices. The Bivariate Weibull regression can be expressed as:

$$F ( t , u ) = 1 - exp \{ - {[ {( \frac{t}{{η}_{t}} )}^{{β}_{t}} + {( \frac{U}{{η}_{u}} )}^{{β}_{u}} ]}^{δ}$$

where ηₜ, ηᵤ, βₜ, βᵤ and δ are parameters of the model, t is operating time; and u is the usage/health severity level, which is derived from the health indices.

In a particularly preferred embodiment, the calculated failure risk further includes a multivariate Weibull regression that accounts for time, measured health indices and environmental, regional variables. The environmental regional variables may include, for example, information about the location of the pumping system 100 (e.g., reservoir conditions) and operating characteristics (e.g., demands of the pumping application). The multivariate hazard rate equation is preferably expressed as:

λᵢⱼₖ(t)=λ₀(t)exp[Hᵢⱼₖβ+δⱼₖ+δₖ], where

Hᵢⱼₖ=health index of pump i at site j in region k

δⱼₖ=site level effects

δⱼₖ=region level effects, and

S(t)Hᵢⱼₖ,δⱼₖ,δₖ=exp[−∫₀^{t}λᵢⱼₖ(t)dt], where

F(t)=1−S(t) expresses the probability of failure.

The total number of failures that can be expected per well over an extended period is therefore:

$$M ( t ) = F ( t ) + {\int }_{o}^{t} F ( t - y ) d F ( y )$$

This presents the standard renewal equation that can be solved using Monte-Carlo methods or recursive logic (depending on the complexity of λᵢⱼₖ(t)). Thus, using these methods, the probability of failure can be predicted while incorporating environmental and application-specific variables for a particular piece of equipment and groups of equipment.

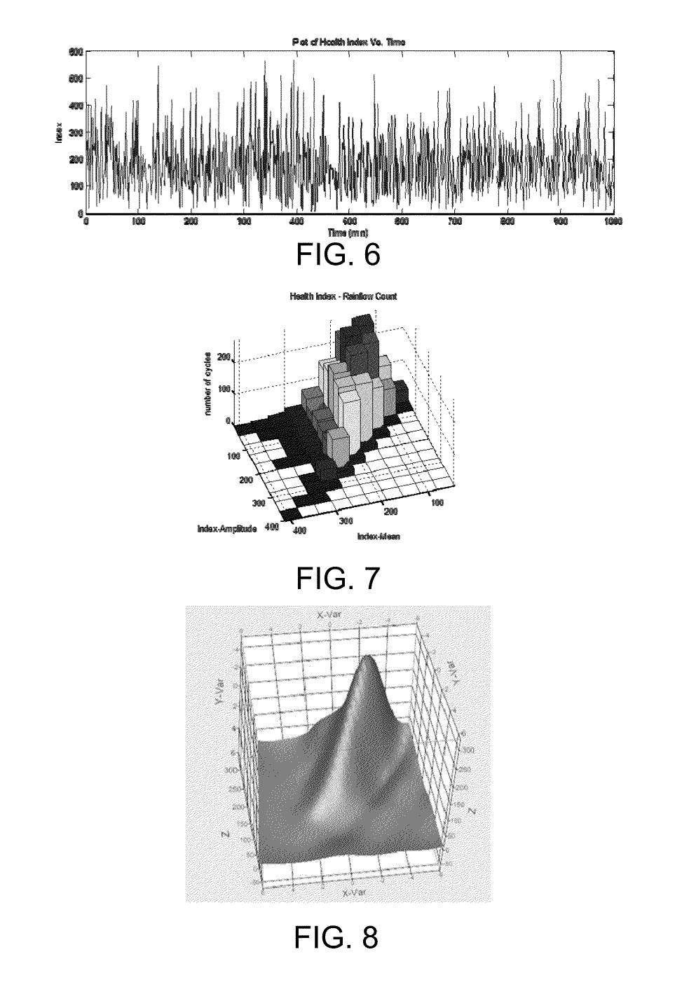

Continuing with the general method depicted in FIG. 5, but now referring also to FIGS. 6-8, shown therein are graphical representations of a particularly preferred embodiment of the step of generating multi-level survival models. With reference to FIG. 6, shown therein is a graphic representation of the aggregated health indices plotted against time. This graph shows a typical time series of the health indices/fused features from the pumping system 100, after primary signal processing is complete.

Turning to FIG. 7, shown therein is the output of rainflow counting on the health index produced by the pumping system 100 and charted in FIG. 6. The rainflow counting methodology is used to reduce a spectrum of varying stress into a set of simple stress reversals. A coarse binning is shown in FIG. 7 to illustrate the underlying concept. In a presently preferred embodiment, standard ASTM International approaches are used to extract the peaks and weight certain regions distinctly. Based on empirical results, bins and some combinations of bins are known to cause more damage due to certain design considerations in the pumping system 100, and are therefore “inflated” by a selected damage equivalence ratio.

Using the output from the rainflow counting algorithm, the multivariate Gaussian surface approximation in FIG. 8 can be generated. The curves produced in FIG. 8 can be established using multivariate probability fitting models that are similar to Kriging techniques used in spatial statistics. For example, in a first preferred embodiment, the response, Z, (in this case the expected cycles at point rᵢⱼ, where rᵢⱼ is the point corresponding to a (Index_Mean, Index_Amplitude) combination, is written as “Z˜(Multivariate) normally distributed by mean μ and covariance matrix σ2R.” Assuming Gaussian correlation, the R matrix has the elements given by the following equation (where Theta is a model parameter that is estimated):

$${r}_{ij} = exp ( - {\sum }_{k}^{ } {{θ}_{k} ( {x}_{ik} - {x}_{jk} )}^{2} )$$

In other examples, it may be useful to assume a cubic correlation structure, where R takes the form:

$${r}_{ij} = {\prod }_{k}^{ } ρ ( d ; {θ}_{k} ) , \\ where$$

$$d = {x}_{ik} - {x}_{jk} and the rho parameter is \text{:}$$

$$ρ ( d ; θ ) = \{ \begin{matrix}1 - 6 {( d θ )}^{2} + 6 {( \vert d \vert θ )}^{3} , & \vert d \vert \leq \frac{1}{2 θ} \\ 2 {( 1 - \vert d \vert θ )}^{3} , & \frac{1}{2 θ} < \vert d \vert \leq \frac{1}{ θ} \\ 0 , & \frac{1}{ θ} < \vert d \vert\end{matrix}$$

The accuracy of these fitting methods can be evaluated using a variety of methods including, but not limited to, Akaike Information Criteria (Corrected)(AICc), Bayes Information Criteria (BIC) or LogLikelihood (−2*LL). Using the equations extracted from these curves, the multi-level survival models can be established and applied.

Continuing with FIG. 5, the central data center 134 applies the specific health indices to the multi-level survival models to produce one or more selected outputs at step 406. Outputs include, but are not limited to, risk analysis reports and operating instructions for pumping systems 100. The outputs from the central data center 134 can be used to calculate the failure risk and remaining useful life of a particular pumping system 100 system, groups of pumping systems 100 and broad categories of pumping systems 100. As noted at step 406, the outputs of the method 400 can be generally be categorized into technical risks, operational risks and financial risks.

For technical risks, the results of the application of the multi-level survival models can be used to identify premature equipment failures attributable to design and manufacturing issues. With this information, improvements to product design and manufacturing techniques can be adopted and implemented. In a particularly preferred embodiment, the outputs produced by the central data center 134 are used to select the best combination of components within the pumping system 100 for particular applications (e.g., heavy oils vs. light oils).

For operational risks, the broad comparison of health indices obtained from pumping systems 100 operated under varying conditions can be used to prescribe optimized performance protocols (e.g., pump speed), schedule maintenance, estimate downtime due to service requests and provide availability times.

For financial risks, the generation of the multi-level survival models can be used to predict the remaining useful life of pumping systems 100 and the probability of component failure during the remaining useful life. This information can be used to evaluate the financial risk of long-term service contracts throughout the life of an electrical submersible pumping system. The same information can be used to inform new model pricing information and spare inventory management.

Thus, the preferred embodiments provide a system in which health indices are calculated at discrete pumping systems 100, the health indices from a number of pumping systems 100 are uploaded into a central data center 134, and the uploaded health indices are then coordinated, trended and evaluated to form multi-level survival models. The multi-level survival models can then be used to predict failure, inform design decisions and optimize the performance of pumping systems 100.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention. For example, although the preferred embodiments are described in connection with electric submersible pumping systems, it will be appreciated that the novel systems and methods disclosed herein can find equal applicability to other examples of groups of distributed equipment. The novel systems and methods disclosed herein can be used to monitor, evaluate and optimize the performance of fleet vehicles, natural gas compressors, refinery equipment and other remotely disposed industrial equipment.

It is claimed:

1. A process for producing a risk analysis report for a plurality of pumping systems, the process comprising the steps of:
providing a local control unit at each of the plurality of pumping systems;
providing output signals to each of the plurality of local control units from each of the corresponding pumping systems, wherein each of the output signals is reflective of an operating condition measured at the pumping system;
processing the output signals at each of the plurality of local control units;
producing a health index at each of the plurality of local control units; and
uploading the health index from each of the plurality of local control units to a central data center.

2. The process of claim 1, wherein the step of providing output signals to each of the plurality of local control units further comprises providing on a scheduled periodic basis an output signal selected from the group consisting of: motor voltage, motor current, power factor, pump intake pressure, motor temperature, motor frequency, pump intake temperature, vibration, flowing bottom hole pressure, well head pressure and leakage current.

3. The process of claim 1, wherein the step of processing the output signals at each of the plurality of local control units further comprises performing a statistical analysis on the output signals using multivariate statistical algorithms.

4. The process of claim 3, wherein the step of processing the output signals at each of the plurality of local control units further comprises performing a multivariate statistical algorithm selected from the group consisting of: probability-density based usage indices, multivariate Hotelling T-squared distributions, change point detection algorithms, and Bayesian and neural network-based anomaly detection and classification algorithms.

5. The process of claim 1, further comprising the steps of:
categorizing at the central data center the health indices received from the plurality of local control units; and
generating a multi-level survival model based on the categorized health indices.

6. The process of claim 5, wherein the step of categorizing at the central data center the health indices received from the plurality of local control units further comprises categorizing the health indices according to classes selected from the group consisting of equipment models, geographic regions and downhole applications.

7. The process of claim 5, wherein the step of generating a multi-level survival model further comprises trending the categorized health indices to produce multi-level survival models.

8. The process of claim 7, wherein the step of generating a multi-level survival model further comprises trending the categorized health indices to produce multi-level survival models at regional, site and individual pumping system levels.

9. The process of claim 5, further comprising the steps of:
applying health indices specific to a selected pumping system to the multi-level survival model; and
generating the risk analysis report for the selected pumping system based on the application of the specific health indices within the multi-level survival model.

10. The process of claim 9, wherein the step of generating the risk analysis report for the selected pumping system based on the application of the specific health indices within the multi-level survival model further comprises generating a risk analysis report selected from the group consisting of technical risk report, operational risk report and financial risk report.

11. The process of claim 10, wherein the step of generating the risk analysis report for the selected pumping system further comprises generating the risk analysis report for a plurality of selected pumping systems.

12. A process for optimizing the performance of a selected pumping system within a plurality of pumping systems, the process comprising the steps of:
providing a local control unit at each of the plurality of pumping systems;
providing output signals to each of the plurality of local control units from each of the corresponding pumping systems, wherein each of the output signals is reflective of an operating condition measured at the pumping system;
processing the output signals at each of the plurality of local control units;
producing a health index at each of the plurality of local control units;
uploading the health index from each of the plurality of local control units to a central data center;
categorizing at the central data center the health indices received from the plurality of local control units;
generating a multi-level survival model based on the categorized health indices; and
applying health indices specific to the selected pumping system to the multi-level survival model to produce optimized operating instructions; and
adjusting the operational characteristics of the selected pumping system in accordance with the optimized operating instructions.

13. The process of claim 12, wherein the step of uploading the health index from each of the plurality of local control units to a central data center further comprises uploading the health indices over a wide area network.

14. The process of claim 12, wherein the step of adjusting the operational characteristics of the selected pumping system further comprises adjusting the operational characteristics of the selected pumping system from the central data center over a wide area network.

15. A process for producing a financial risk report for a long-term service contract for a selected pumping system within a plurality of pumping systems, the process comprising the steps of:
providing a local control unit at each of the plurality of pumping systems;
providing output signals to each of the plurality of local control units from each of the corresponding pumping systems, wherein each of the output signals is reflective of an operating condition measured at the pumping system;
processing the output signals at each of the plurality of local control units;
producing a health index at each of the plurality of local control units;
uploading the health index from each of the plurality of local control units to a central data center;
categorizing at the central data center the health indices received from the plurality of local control units;
generating a multi-level survival model based on the categorized health indices; and
applying health indices specific to the selected pumping system to the multi-level survival model to determine failure rate information for the selected pumping system; and
generating the financial risk report for the long-term service contract based on the determined failure rate information.
